(19) United States
(12) Patent Application Publication
(10) Pub. No.: US 2004/0070671 A1
(43) Pub. Date: Apr. 15, 2004

(54) HalloMyHome, an internet service automatically communicating images from home, or other physical location, to a mobile telephone

(76) Inventor: Anders Ola Bengtsson, Bjarred (SE)

Correspondence Address: ANDERS OLA BENGTSSON, PILEVAGEN 2, BJARRED, S-23736, SE

(21) Appl. No.: 10/390,932

(22) Filed: Mar. 19, 2003

Related U.S. Application Data
(60) Provisional application No. 60/368,039, filed on Mar. 28, 2002.

(51) Int. Cl. H04N 5/225; H04Q 7/20; H04B 7/00

(52) U.S. Cl. 348/207.1; 455/41.3; 455/426.1

(57) ABSTRACT

In a mobile and broadband internet environment having a camera that automatically sends pictures from your home, or other location, to your mobile unit.

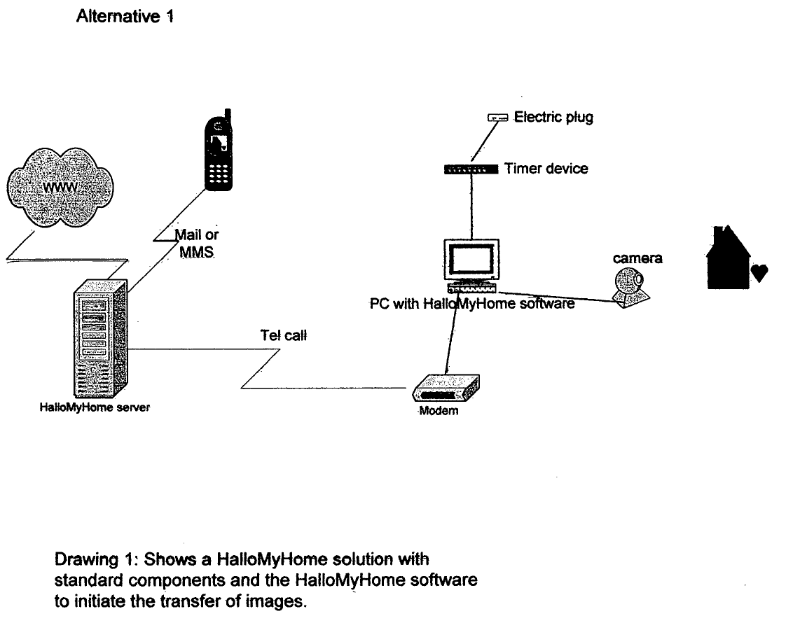

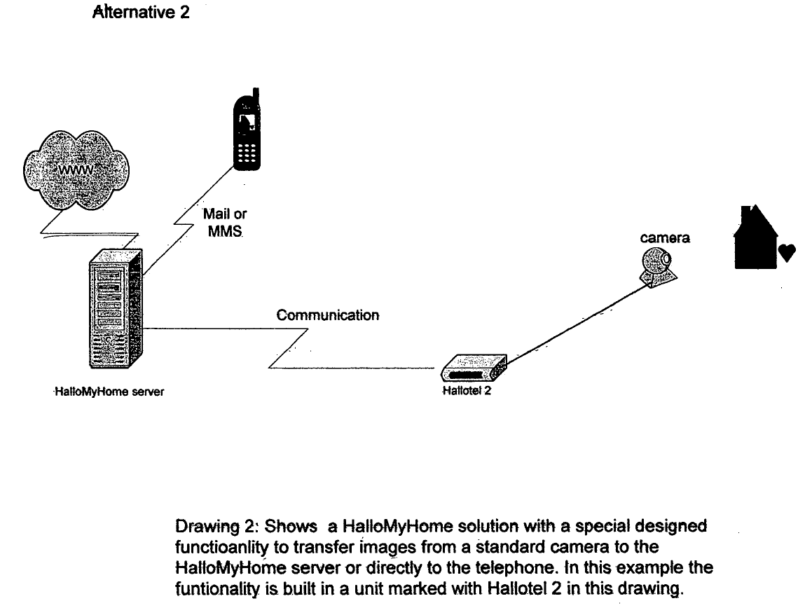

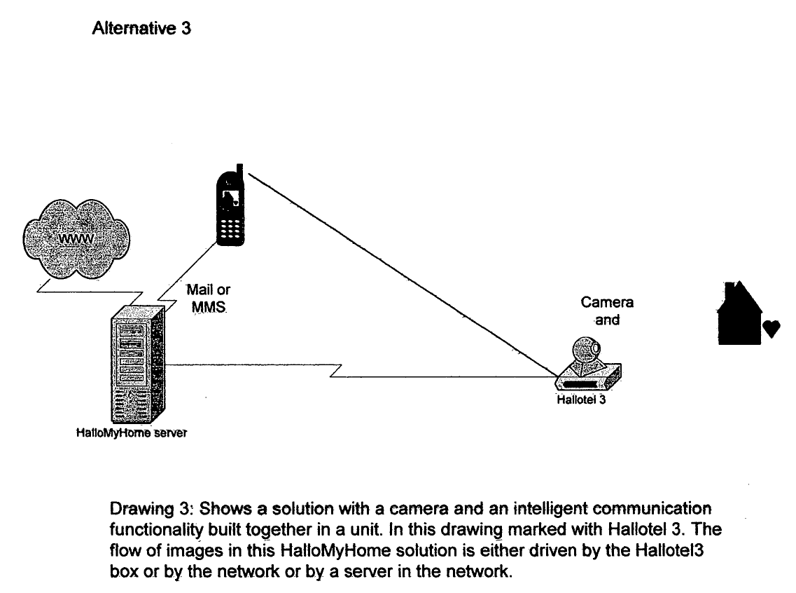

### BACKGROUND OF THE INVENTION

With reference to the provisional application No. 60/368,039. Filing date Mar. 28, 2002.

To most people the home represent a valuable asset. When away there is a natural need for information from home.

Realising the potential coming from the new mobile telephones that can receive and send images and Broadband Internet communications.

True mobility, addressing the issue what information do you need when away from home.

The purpose of the invention is to create a service that automatically sends images, or other information, from a web camera at your home, or other location, to your mobile unit.

It is a technical challenge to send the images s from your home when you are away and no one else is home to send the images to you. Obviously it is not realistic to have the PC running all the time. This invention solves this in a cost effective and simple way.

### DESCRIPTION OF THE PRIOR ART

Not available.

### BRIEF SUMMARY OF THE INVENTION

The HalloMyHome service uses the new mobile and broadband internet to automatically communicate images from your home, or other location, to your mobile telephone, or other mobile unit.

From a mobile log on to the HalloMyHome service site and you will see the picture or movie from the webcamera, or other camera, in your own home.

Another alternative is that the HalloMyHome service automatically, at pre defined intervals or continuously sends pictures from the webcamera to the mobile.

The HalloMyHome service comprises a camera with an internet connection.

The HalloMyHome service comprises an internet service for storing and communicating the picture.

The HalloMyHome service comprises an authentication procedure securing that your pictures can only be seen after secure login and authentication.

The HalloMyHome service comprises a device (Hallotel box) that can connect the camera to the internet.

The HalloMyHome service comprises a software which is initiated when the computer starts.

Said software initiates the transfer of the image from the camera to the computer thereafter the sends the image to a predefined address. Finally the software automatically shuts down the PC.

The HalloMyHome service comprises a timer device that at predefined intervals switch on and off the electrical power supply to the PC.

### BRIEF DESCRIPTION OF THE SEVERAL VIEWS OF THE DRAWING

Drawing 1

Shows a cost effective solution that uses slightly modified standard components and the HalloMyHome software to be installed at the customers PC. Very low initial cost. It also shows a modified timer device and the HalloMyHome software.

Drawing 2

Shows a solution that excludes the need to involve a PC but requires a somewhat higher initial cost compared to alternative 1 described in this document. The server sends picture to the mobile unit or units-at specified intervals.

Drawing 3

The communication unit has a built in camera and the unit can communicate the images by itself either via connection to the telephone jack or via a built in mobile card.

### DETAILED DESCRIPTION OF THE INVENTION

The HalloMyHome service can be realized in a number of ways.

The technical challenge is that you want to receive images from your home when you are away and no one else is home.

How to establish this in the most cost effective way?

The invention defines alternative ways to solve this. Which solution that is the most cost effective may vary over time.

Alternative 1—which is a cost effective solution that uses slightly modified standard components and a unique HalloMyHome software to be installed at the customers PC. This solution gives a very low initial cost.

The standard webcamera is connected to a PC. The PC is equipped with a modem which is connected to the telephone jacket. At predefined intervals an electric timer device switches on the electric power supply to the computer. The HalloMyHome software is automatically started when the computer starts. The software initiates the transfer of the image from the camera to the computer and stores it. Thereafter the software starts a standard e mail software installed on the computer and creates a mail with the image attached. The software initiates that the mail is sent to the predefined e mail address or to a mobile telephone as MMS. Thereafter it shuts down the operating system on the computer. After a predefined time the timer device switches off the electric power supply. This procedure is repeated at the predefined intervals set on the timer device.

Alternative 2—

This alternative excludes the need to involve a PC but requires a somewhat higher initial cost compared to alternative 1 as above.

When the HalloMyHome server calls to the Hallotel box, if no one answers the telephone the Hallotel box will automatically answer the signal and wait for the identification code. If the code is ok the Hallotel box will switch on the power to the PC. The Hallo Software which is a small software that is installed in the PC and initiates a download from the webcamera to the PC and thereafter initiates that the image is sent as attachment in a mail or as an MMS or downloaded to the HalloMyHome server. From there the image can be either sent as an MMS or be viewed at the site after login procedure.

Alternative 3—

The camera and a mobile unit is built together and incorporates a software that can send images as MMS or mail either via the HalloMyHome server or directly to predefined mobile telephone.

A webcamera or other devise for creating pictures are placed at your home. The home is equipped with a broadband connection. The webcamera is connected to the broadband and equipped with a firewall application to prevent from unauthorized access.

The HalloMyHome service is set up with an application that communicates with the webcamera and transferring pictures or movies from it.

The HalloMyHome internet service is set up with an application that communicates pictures or movies from the HalloMyHome server to the mobile unit.

The HalloMyHome internet service is set up with log on and authentication procedure when access is accepted it is possible to se the pictures or movies from your home or other location in real time.

1. A system that automatically communicates images from a location fx a home, to a mobile unit fx a mobile telephone

2. A system as described in claim 1 comprising:
means for secure access;
means for establishing connection with the camera;
means for transferring the image from the camera either via an internet service or directly to the mobile unit.

3. A system establishing communication between the camera and fx internet and thus making it possible to transfer images or movies.

4. A system automatically initiating a camera to send images to a mobile telephone or other mobile unit.

5. A system as described in claim 4 characterized in that the customer PC has a software which automatically starts when the PC starts and initiates the transfer of the image from the camera to the computer, stores it and sends the image to the mobile telephone or other unit. Thereafter it shuts down the computer.

6. A system as claimed in claim 4 characterized in that it has a timer device which switches on/off the power supply to the computer at predefined time intervals and thus initiates the communication process.

7. A system as claimed in claim 4 characterized in that it contains a device that automatically establishes connection between the camera and the mobile telephone or internet.
